(19) United States
(12) Patent Application Publication
(10) Pub. No.: US 2009/0049810 A1
(43) Pub. Date: Feb. 26, 2009

(54) DUST FILTRATION BAG AND FRAME APPARATUS AND METHOD

(76) Inventors: Thomas B. GREEN, Liberty Township, OH (US); Travle Haynam, Maineville, OH (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(21) Appl. No.: 11/843,892

(22) Filed: Aug. 23, 2007

(51) Int. Cl. B01D 46/02

(52) U.S. Cl. 55/378

(57) ABSTRACT

Presented is an improved dust filtration unit of the type characterized by a filter bag having a plurality of pockets conjoined to a unitary opening, the opening having a collar that extends circumferentially around the opening, and a frame for supporting individual pockets and circumferentially supporting the opening. The improvement includes the frame having circumferential sidewalls with substantially vertical portions and top edges. A flange extends outwardly from the top edges to define a parameter and the filter bag includes an elastic hem at an outer edge of the collar. The bag is inserted within the sidewalls of the frame and the elastic hem edge of the collar is stretched over the flange for supporting attachment thereto.

### TECHNICAL FIELD

This invention relates to an improved filter bag and frame combination for use in a compact self-contained dust collector in light industrial use. In particular, the invention relates to the combination of a multi-pocket filter bag with a collar having an elastic hem that can easily be stretched over a frame having an outwardly-extending flange for secure attachment.

### BACKGROUND OF THE INVENTION

An air filtering apparatus may take a variety of forms depending upon the application for which it is intended. In industrial applications, the filtration unit typically includes a housing, sometimes referred to as a bag house, that is divided into two internal chambers: 1) a dirty air chamber and 2) a clean air chamber. The two chambers are divided by a wall, known as a tube sheet, on which some type of filter media is mounted such that contaminated air is drawn by a fan into the dirty air chamber, through the filter media and openings in the tube sheet, to the clean air chamber. The filtered air is then either exhausted to the outside atmosphere or recycled to the industrial work environment.

One popular form of filter medium is a plurality of relatively flat bag or pocket type filters positioned in a side-by-side relationship and suspended from a frame. This type of filter provides maximal surface area through which the dirty air is drawn, allowing large amounts of contaminants to be collected prior to the filter media becoming clogged. Typically, the collection bag or pockets are occasionally shaken in order to physically dislodge accumulated particulates so that they may be collected for disposal and the useful life of the filter extended between more thorough cleanings or replacement.

The principles of operation summarized above are described in U.S. Pat. No. 3,733,790, issued May 22, 1973, to Leo A. Pierce, the specification of which is incorporated by reference herein. Several evolutionary improvements have been made to that apparatus, including improvements on how the plurality of filter bags are assembled, mounted, and installed. For example, U.S. Pat. No. 4,323,376, issued Apr. 6, 1982, to Arthur P. Rosenquest discloses an improved filter bag construction in which the plurality of bags are unitarily formed, can be hung on a support frame, and lifted as a unit by means of a mechanical apparatus into sealing contact with the tube sheet. Yet another means for addressing the securement of a filter bag to a frame is shown in U.S. Pat. No. 6,740,142, issued May 25, 2004, to John M. Buettner, et.al., specifically at FIG. 7. Another method for assembling and installing a multi-pocket filter bag on a support frame is described in U.S. Pat. No. 5,931,988, issued Aug. 3, 1999, to LeBlanc, et al. These references are also incorporated herein by reference and should be considered by the reader in order to put the present invention into proper context.

Another prior art design (which will be described in greater detail below) is shown in FIGS. 3, 4 and 5, herein. This design is presently in common use. A plurality of bag pockets are conjoined to a single opening to form a filter bag unit. The opening has an extended collar of material that extends circumferentially around the opening. The bag is supported on a frame with an upwardly extending edge. The collar portion is folded over to an overlapping position on the outside of the frame and a retainer is inserted on the inner side of the frame, gripping a portion of the bag collar therebetween.

Each of the above-described embodiments, though improvements in their own right over the original design, remain difficult for an untrained or unskilled person to properly assemble and position without engaging in many frustrating attempts. Units in which this type of filter assembly are used may be found in service in light duty situations, such as dust collection for a high school or vocational school shop. In such installations, it is often the building custodian, rather than a specially trained technician, who is responsible for routine maintenance and replacement of filter bag units. A simple, reliable and low cost solution for inserting and attaching the multi-pocket filter bag to the frame and insertion into position against the tube sheet is needed.

### SUMMARY OF THE INVENTION

The present invention provides an improved dust filtration unit of the type characterized by a filter bag having a plurality of pockets conjoined to a unitary opening with the opening having a collar that extends circumferentially around the opening and a frame for supporting individual pockets and circumferentially supporting the opening. The improvements comprise the frame having a circumferentially flange outwardly extending from the frame to define a perimeter. The filter bag includes an elastic or drawstring hem at the outer edge of the collar such that, when the bag is inserted within the frame, the hem edge of the collar may be stretched over the flange for secure supporting attachment thereto.

The outwardly extending flange provides a widened face against which the collar can be engaged against an elastomeric gasket when installed in the filtration unit. The frame may include substantially vertical sidewall portions having an upper or other edge from which the circumferentially flange outwardly extends.

According to another aspect of the invention, it includes a method of assembling a filter bag onto a support frame comprising the steps of providing a filter bag having a plurality of pockets conjoined to a unitary opening. The opening has a collar that extends circumferentially around the opening and includes an elastic or drawstring hem at an outer edge of the collar. A frame is provided having a circumferential flange outwardly extending from an edge of the frame to define a perimeter. The bag is inserted into the frame and the elastic or drawstring hem edge of the collar is stretched over the flange and drawn tight for supporting attachment thereto.

### BRIEF DESCRIPTION OF THE DRAWING

Like reference numerals are used to denote like parts throughout various figures of the drawing, wherein:

FIG. 1 is a pictorial view of the external structure of a compact self-contained shaker-type dust collector in which the present invention may be used;

FIG. 2 is a partially cut-away pictorial view of the unit shown in FIG. 1;

FIG. 3 is an exploded view of a prior art filter bag and frame assembly;

FIG. 4 is a partial, cross-sectional view taken substantially along line 4-4 of FIG. 3 showing a detail of the assembled prior art frame and bag combination;

FIG. 5 is a partially-disassembled pictorial view of the bag and frame combination of the prior art being inserted into its housing in the same manner as the present invention;

FIG. 6 is an exploded pictorial view of the filter bag and frame combination of the present invention; and

FIG. 7 is a detail cross-sectional view taken substantially along line 7-7 of FIG. 6 detail of a bag supported by a frame according to an embodiment of the present invention;

### DETAILED DESCRIPTION AND BEST MODE FOR CARRYING OUT THE INVENTION

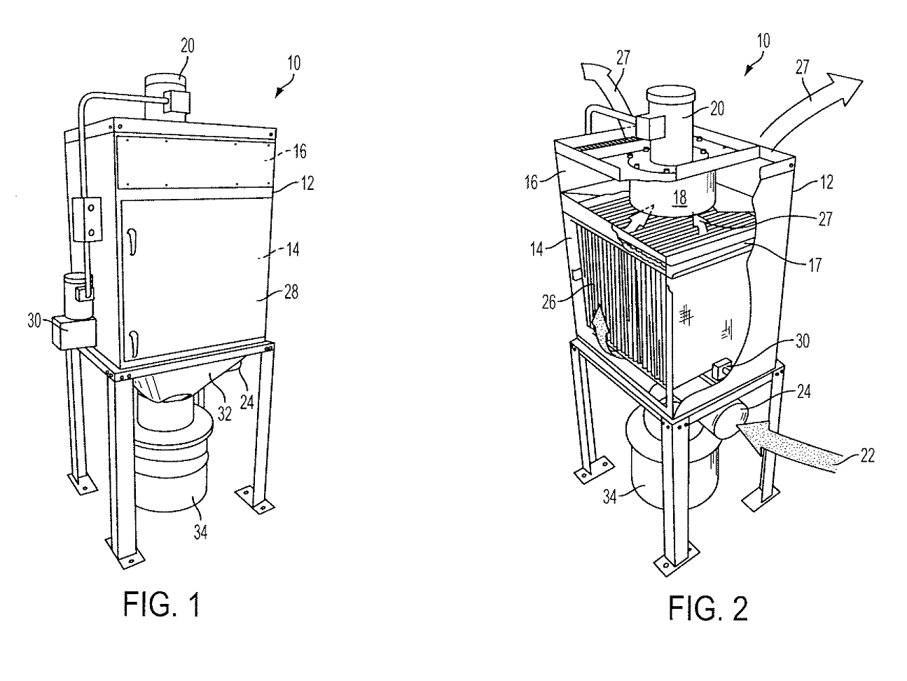

Referring to the various figures of the drawing, and first to FIGS. 1 and 2, therein is shown at 10 a typical compact, self-contained, shaker-type dust collection apparatus in which the present invention may be used. A housing or cabinet 12 provides an enclosure divided into two internal chambers: a dirty air or contaminated air chamber 14 and a clean air chamber 16. A blower or fan 18, typically powered by an electric motor 20, may be positioned within or adjacent to the clean air chamber 16. An internal wall or partition, known as the tube sheet 17, separates the dirty and clean air chambers 14, 16. The fan 18 draws contaminated air 22 through an inlet 24, into the dirty chamber 14, and through the filter media 26 which is sealed against the tube sheet 17. Access to the dirty air chamber 14 and the filter media 26 inside is commonly had through a hinged door 28 on the front of the unit 10. Having particulate contaminants removed therefrom, clean air (shown by arrows 27 in FIG. 2) is drawn through the fan 18 and is either exhausted out through the top of the unit to the outdoor atmosphere or may be recycled into the work environment.

The filtration apparatus 10 may also include a vibrating mechanism 30 of well known construction which, when the dust collecting apparatus is not operating, mechanically dislodges heavy accumulations of particulate contaminates (dust) from the filter media 26. After being shaken off the filter media 26, the particulate contaminants fall by gravity into a collection chute 32 and further into a collection bin 34, which may be emptied as required.

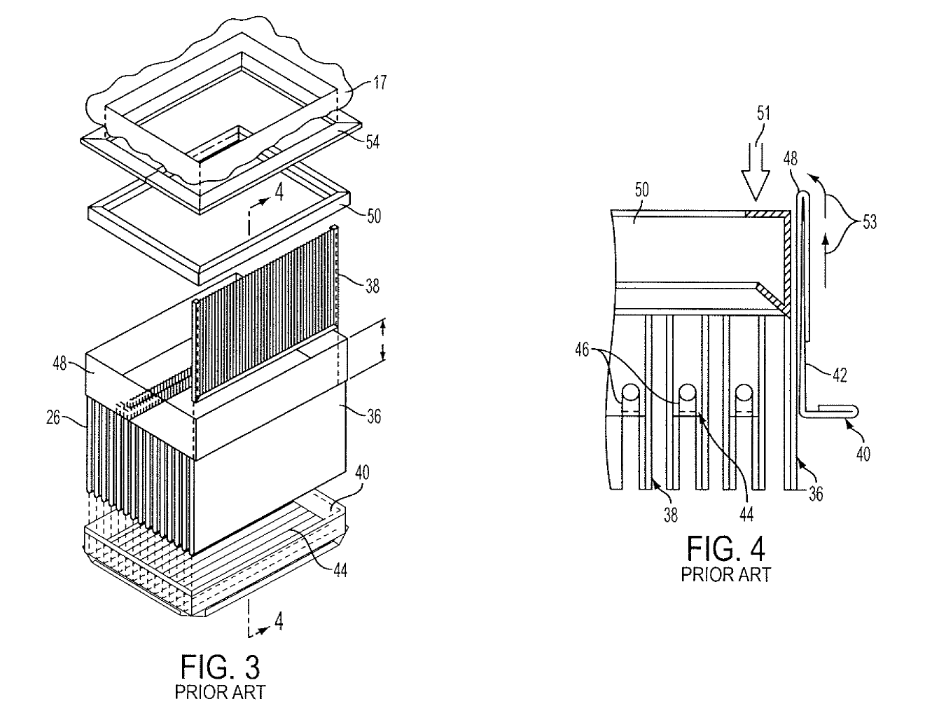

Referring now to FIGS. 3, 4 and 5, as is well known in the prior art, a fabric filter cloth bag 36 may be formed as a series of essentially u-shaped parallel folds with closed sides into which a relatively rigid, porous spacer material 38 is inserted. The filter bag 36 is then inserted into a rectangular frame structure 40 having upwardly-directed sidewalls 42 and a series of parallel rods 44 extended between opposite sides of the frame. Each fold 46 of the bag 36 forms a separate pocket and is held in position by the rigid spacers 38 and support rods 44. In this manner, the pockets are conjoined to a unitary opening having a fabric collar 48 that extends circumferentially around the opening.

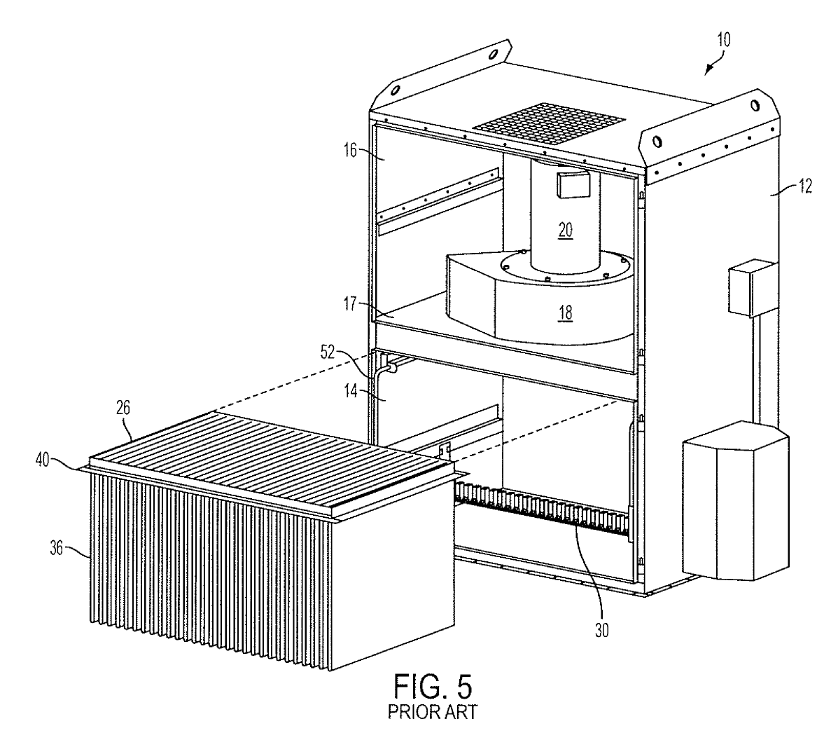

In the prior art design, the collar portion 48 of the bag 36 is folded over the upwardly directed sidewall 42 of the frame 40 (see FIG. 4). After the collar 48 is folded over the outside of the frame 40, a retainer ring 50 is inserted within the frame 40 such that the collar 48 is tightly clamped between the two frame parts 40, 50. Referring particularly to FIGS. 3 and 5, the assembled filter media unit 26 is then slid into the housing 12 onto a lifting mechanism 52 and, along with an elastomeric gasket 54, is lifted into sealing engagement with the tube sheet 17. Although assembly of the bag 36 to the frame 40 in this manner provides a secure attachment once the unit is in place, maintaining the collar 48 in place over the upwardly extending sidewall 42 of the frame 40 while inserting the retainer ring 50 and moving the assembled unit into the housing 12 can be quite challenging for a untrained person servicing the unit 10.

Referring in particular to FIG. 4, it is readily seen that moving the retaining ring 50 downward (arrow 51) into position will inherently cause the folded-over edge of the collar 48 to slip upward (arrow 53) and out of a secure position.

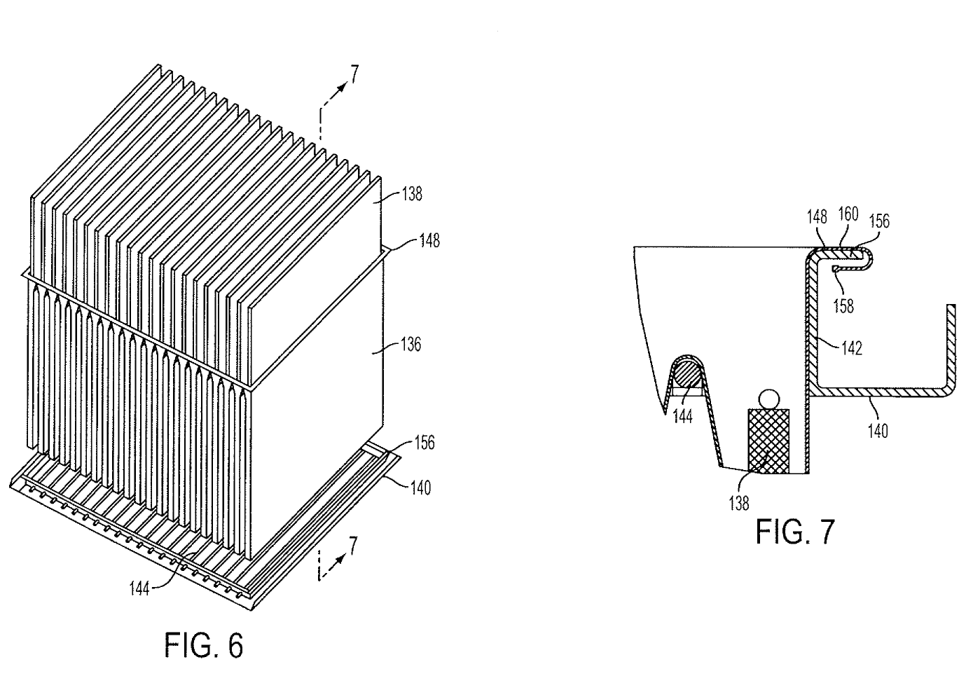

The present invention provides a simple and low cost solution to this problem. Referring now to FIGS. 6 and 7, therein is shown a preferred embodiment of the present invention. The pockets of the filter bag 136 are formed in the typical way and receive rigid, porous spacer pieces 138. The frame 140 includes the same type of support rods 144 extending between opposite sides of the frame 140. The frame 140 differs, however, in that the sidewall 142, which can include an upwardly-extending, substantially vertical portion, has an outwardly extending flange 156. The flange 156 is preferably located at the top edge of the sidewall 142, but may be at any position on the outer side of the frame 140. In a preferred form, the collar portion 148 of the bag 136 includes an elastic hem 158 that may be sewn onto the collar in the typical way that an elastic cuff is formed in a sleeve, for example. Alternatively, the hem edge may include a manually retractable drawstring that can be pulled tight and secured in place over the flange 156.

In practice, the rigid spacers 138 are inserted into the pockets of the bag 136 and inserted into the frame 140 in the ordinary way. However, the collar portion 148 of the bag 136 is simply fitted over the outwardly directed flange 156 by stretching the elastic or securing the drawstring hem 158. The bag 136 and collar 148 are now securely held in place without the need for a retainer ring (shown at 50 in FIG. 3). The assembled unit is then easily insertable onto the lifting mechanism 52 without risk of dislodging the collar 148 from its secure position on the frame 140. A wide and smooth (not sharp) surface 160 is presented by the assembled unit for sealing engagement against an elastomeric gasket (shown at 54 in FIG. 3).

The outwardly extending flange 158 can take any suitable form or be of any width sufficient to cause the collar 148 of the bag 136 to remain secure on the frame 140. Many other variations may be made to the illustrated and described embodiment without departing from the spirit and scope of the invention.

What I claim is:

1. An improved dust filtration unit of the type characterized by a filter bag having a plurality of pockets conjoined to a unitary opening, the opening having a collar that extends circumferentially around the opening, and a frame for supporting individual pockets and circumferentially supporting the opening, the improvement comprising:
the frame having a circumferential flange outwardly extending from an edge of the frame to define a parameter; and
the filter bag including a retractable hem at an outer edge of the collar;
wherein the bag is inserted within the frame and the elastic hem edge of the collar is stretched over the flange for supporting attachment thereto.

2. The apparatus of claim 1, wherein the retractable hem edge includes elastic.

3. The apparatus of claim 1, wherein the retractable hem edge includes a drawstring.

4. The apparatus of claim 1, wherein the flange provides a widened face against which the collar can be engaged against an elastomeric gasket.

5. The apparatus of claim 1, wherein the frame includes substantially vertical sidewall portions having an edge from which the circumferential flange outwardly extends.

6. The apparatus of claim 5, wherein the circumferential flange outwardly extends from an upper edge of the substantially vertical sidewall.

7. A method of assembling an air filtration unit filter bag onto a support frame, comprising the steps of:
providing a filter bag having a plurality of pockets conjoined to a unitary opening, the opening having a collar that extends circumferentially around the opening and which includes a retractable hem at an outer edge of the collar;
providing a frame having a circumferential flange outwardly extending from an edge of the frame to define a parameter; and
inserting the bag into the frame and stretching the elastic hem edge of the collar over the flange for supporting attachment thereto.

8. The method of claim 7, wherein the retractable hem edge includes elastic.

9. The apparatus of claim 7, wherein the retractable hem edge includes a drawstring.
